(19) United States
(12) Patent Application Publication
(10) Pub. No.: US 2016/0225097 A1
(43) Pub. Date: Aug. 4, 2016

(54) Method of Detecting Damage and Filing a Claim for an Electrical Appliance

(71) Applicant: Asurvest, Inc, Baltimore, MD (US)

(72) Inventors: Luke Cooper, Baltimore, MD (US); Christopher Garvis, Baltimore, MD (US)

(21) Appl. No.: 14/836,271

(22) Filed: Aug. 26, 2015

Related U.S. Application Data
(60) Provisional application No. 62/112,055, filed on Feb. 4, 2015.

(51) Int. Cl. G06Q 40/08

(52) U.S. Cl. CPC G06Q 40/08

(57) ABSTRACT

A method of detecting damage and filing a claim for an electronic appliance is used to recognize if an electrical appliance has sustained damage and expediting the process of filing a claim for that specific electrical appliance. In order for the method to be performed, an external server is provided. The external server is used to manage electrical appliance profiles for various products and coverage plans. The method includes generating a hardware status report and then generating a damage claim if a hardware malfunction is included in the hardware status report. The damage claim is communicated to the external server so that the damage claim can be used to identify a matching profile. The matching profile contains information used to determine an eligibility status for the specific electrical appliance and the damage being claimed. The method includes sending a reply notification to the user based on the eligibility status.

The current application claims a priority to the U.S. Provisional Patent application Ser. No. 62/112,055 filed on Feb. 4, 2015.

### FIELD OF THE INVENTION

The present invention relates generally to methods for processing insurance claims. More particularly, the present invention relates to a method and system for automatically detecting damage done to an electronic appliance and generating an insurance claim for that electronic appliance.

### BACKGROUND OF THE INVENTION

Electronic appliances such as smartphones, tablets, computers, televisions, and home appliances are all subject to physical damage over the course of their respective product lifespans. Specifically, appliances like smartphones are especially prone to damage from being dropped and from general wear-and-tear. Accordingly, many consumers chose to invest in insurance plans and extended warranties which are designed to protect a consumer from having to purchase a new electrical appliance or pay for repairs in the event that their electrical appliance sustains significant damage or experiences a malfunction. While this system is relatively useful and effective, the process of filing a claim can be relatively complicated.

Accordingly, the present invention provides a means of quickly and easily detecting damage and filing a claim to an insurance provider. The existing process of filing a claim involves filling out forms online and/or speaking with representatives over the phone. The present invention compiles all relevant information needed for filing a claim such that the claim itself can be processed automatically. The present invention is also capable of detecting damage such that any damage that does occur does not go unnoticed and can be claimed immediately. The method of the present invention may be executed by the specific electrical appliance, itself, or may be performed by an appliance monitoring device.

### BRIEF DESCRIPTION OF THE DRAWINGS

FIG. 1 is a flowchart describing the general process of the present invention.

FIG. 2 is a flow chart describing the steps of generating a hardware status report and generating a damage claim for a first embodiment of the present invention, wherein the first embodiment continuously performs the hardware diagnostic process.

FIG. 3 is a flow chart describing the steps of generating a hardware status report for a second embodiment of the present invention, wherein the second embodiment is characterized by a hardware diagnostic process which is triggered by a traumatic incident.

FIG. 4 is a flow chart describing the steps of generating a hardware status report for the second embodiment of the present invention, wherein the hardware status report is triggered using an accelerometer.

FIG. 5 is a flow chart describing the steps of generating a hardware status report for the second embodiment of the present invention, wherein a display screen and an appliance button are provided as operational components.

FIG. 6 is a flow chart describing the steps of generating a hardware status report for the second embodiment of the present invention, wherein an appliance camera is provided as an operational component.

FIG. 7 is a flow chart describing the steps of generating a damage claim for the second embodiment of the present invention.

### DETAILED DESCRIPTION OF THE INVENTION

All illustrations of the drawings are for the purpose of describing selected versions of the present invention and are not intended to limit the scope of the present invention.

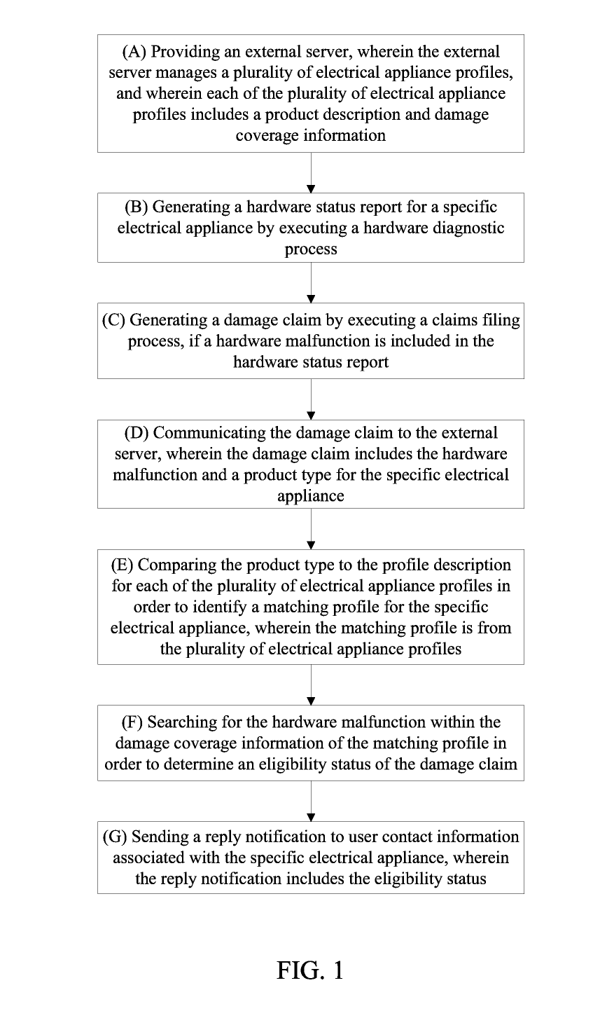

With reference to FIG. 1, the present invention is a method of detecting damage and filing an insurance claim for an electrical appliance by executing computer-executable instructions stored on a non-transitory computer-readable medium. The present invention is used to detect and claim any physical damage that may occur to an electrical appliance. The method of the present invention is performed by a system in which an external server is provided and is used to manage a plurality of electrical appliance profiles, wherein each of the plurality of electrical appliance profiles includes a product description and damage coverage information (Step A). Depending on the embodiment of the present invention, the system may also include an appliance monitoring device or a computing unit which is integrated into the electrical appliance. Each of the electrical appliance profiles corresponds to a specific electrical appliance which is owned by a user. The product description is used to identify the specific electrical appliance, while the damage coverage information describes what circumstances a user is covered for if the specific electrical appliance becomes damaged. The system generates a hardware status report for a specific electrical appliance by executing a hardware diagnostic process (Step B). The hardware diagnostic process is used to detect damage to the specific electrical appliance, while the findings of the hardware diagnostic process are summarized in the hardware status report. Step B may be performed continuously or may be triggered by a traumatic incident. Once the hardware status report is completed, a damage claim is generated by executing a claims filing process, if a hardware malfunction is included in the hardware status report (Step C). Hardware malfunctions may vary in nature but are generally classified as a condition which prevents one or more hardware components from working properly. Hardware malfunctions may arise from damage sustained from impacts, excessive heat, water, faulty components, or component deterioration. The claims filing process is used properly format a damage claim and incorporate all necessary information into the damage claim.

The damage claim is then communicated to the external server, wherein the damage claim includes the hardware malfunction and a product type for the specific electrical appliance (Step D). The product type is information used to identify what type of electrical appliance is being claimed. The product type is compared to the profile description for each of the plurality of electrical appliance profiles in order to identify a matching profile for the specific electrical appliance, wherein the matching profile is from the plurality of electrical appliance profiles (Step E). The matching profile contains information about the specific electronic device and details which types of damage or malfunctions may be covered by insurance. The system then searches for the hardware malfunction within the damage coverage information of the matching profile in order to determine an eligibility status of the damage claim (Step F). Whether or not the hardware malfunction is found within the damage coverage information of the matching profile contributes to the eligibility status, which is used to determine if a user qualifies for a refund, replacement, or some sort of reimbursement for the damage. A reply notification is sent to a user contact information associated with the specific electrical appliance, wherein the reply notification includes the eligibility status (Step G). The reply notification is used to help guide a user through the process of resolving the specific issues being experienced. This process helps to eliminate the possibility of damage to an electronic appliance going unnoticed, while also simplifying and expediting the process of filing a claim.

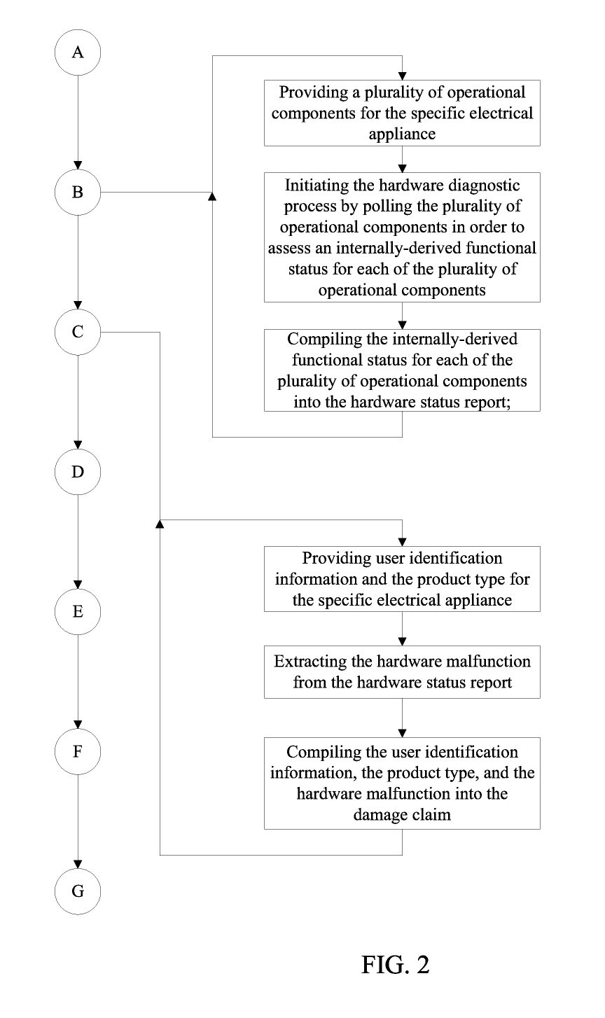

As with most electrical appliances, a plurality of operational components is provided for the specific electrical appliance. In a first embodiment of the present invention, the hardware diagnostic process is initiated by polling the plurality of operational components in order to assess an internally-derived functional status for each of the plurality of operational components. This is shown in FIG. 2. The internally-derived functional status may simply declare whether a certain component is working correctly or not. Alternatively, the internally-derived functional status may contain information regarding the extent to which an operational component is working. For example, a battery may only be capable of charging to 75% capacity. The internally-derived functional status for each of the plurality of operational components is compiled into the hardware status report. This process may be continuously repeated so as to constantly scan for malfunctions.

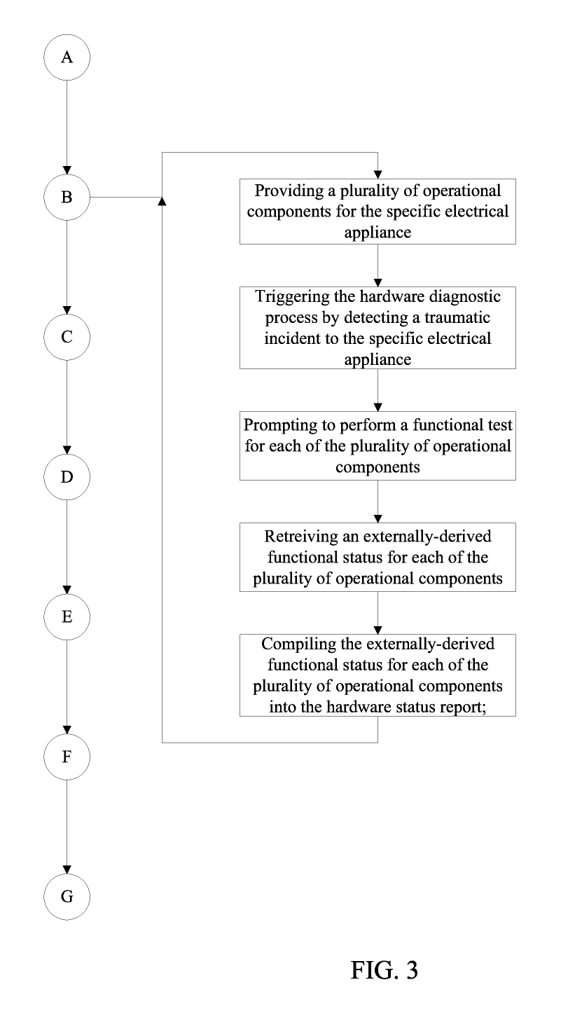

In a second embodiment of the present invention, the hardware diagnostic process is triggered by detecting a traumatic incident to the specific electrical appliance. This process is shown in FIG. 3. The traumatic incident may be signified by a number of circumstances. Such circumstances could include fall damage, water damage, or overheating. When a traumatic incident is detected, the system prompts the user to perform a functional test for each of the plurality of operational components. The system then retrieves an externally-derived functional status for each of the plurality of operational components. Similar to the internally-derived functional status, the externally-derived functional status is used to determine if each of the plurality of operational components is functioning properly. If, for example, the electrical appliance is a smartphone with the system installed as a mobile software application, a traumatic incident would lead to a user notification and prompting the user to enter information used as the externally-derived functional status. The externally-derived functional status for each of the plurality of operational components is then compiled into the hardware status report. This process is useful because the immediate triggering of the hardware diagnostic process after the detection of a traumatic incident allows for any form of damage to be quickly recognized, thus preventing the possibility of damage going unnoticed.

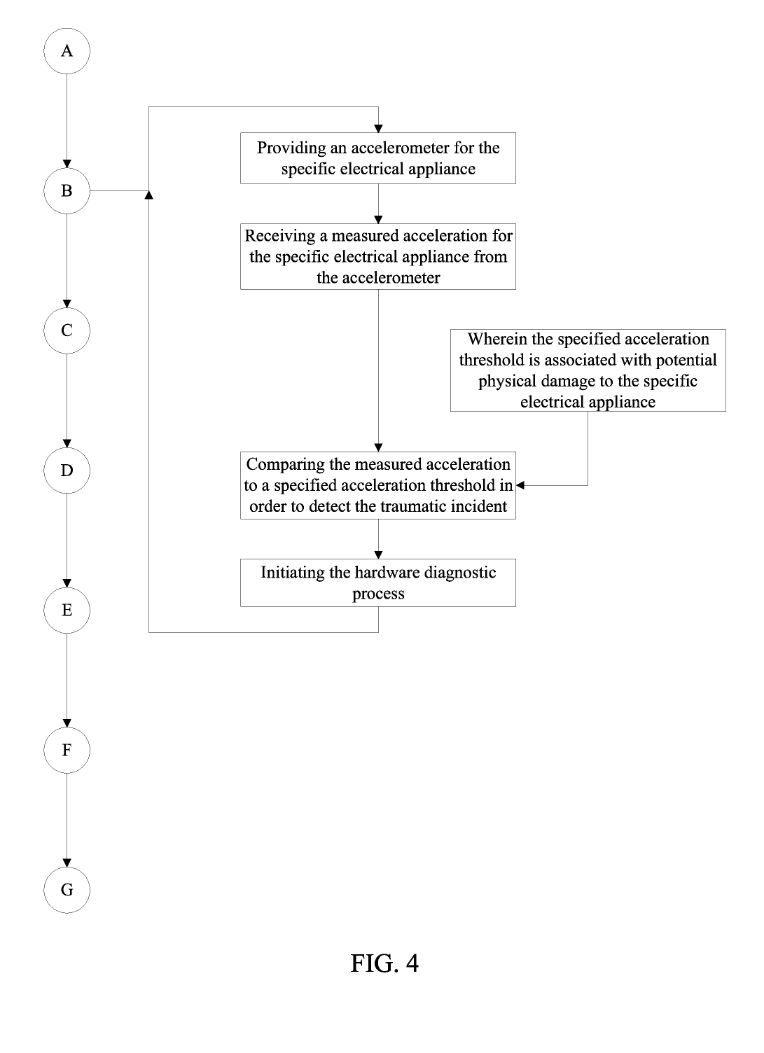

In order to detect potential physical damage due to a fall, an accelerometer, which is provided for the specific electrical appliance, may be used. In reference to FIG. 4, the accelerometer may be used to detect a traumatic incident. To detect a traumatic incident, a measured acceleration for the specific electrical appliance is received from the accelerometer. The measured acceleration is then compared to a specified acceleration threshold in order to detect the traumatic incident, wherein the specified acceleration threshold is associated with potential physical damage to the specific electrical appliance. The hardware diagnostic process is initiated if the measured acceleration is greater than the specified acceleration threshold. Otherwise, no action will be taken.

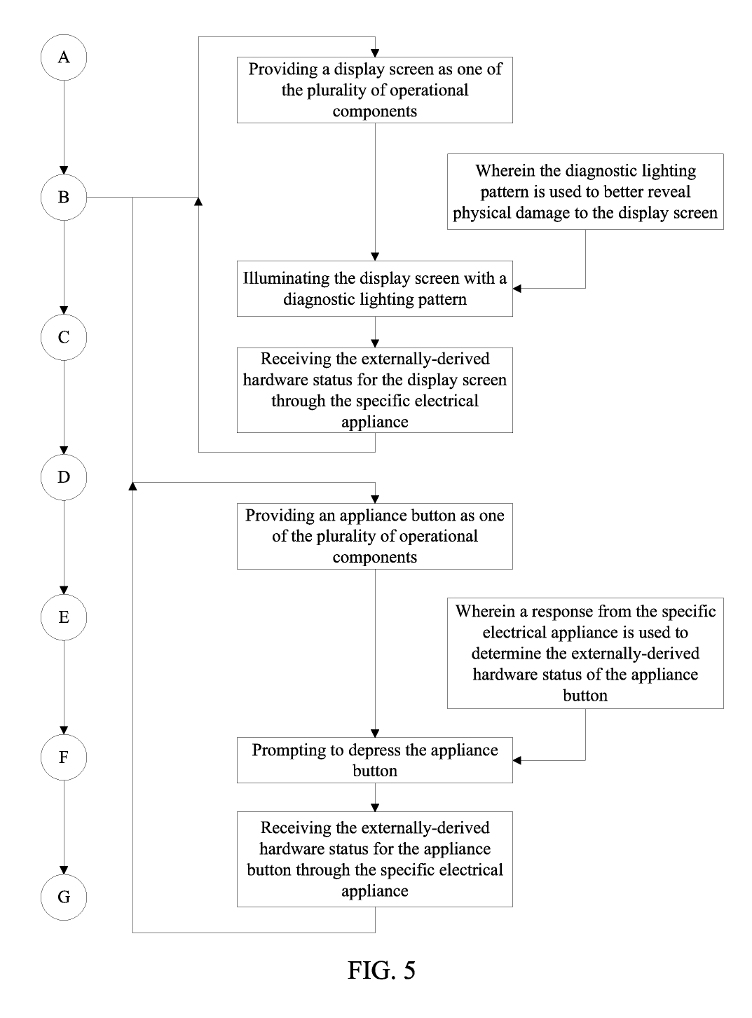

In reference to FIG. 5, the second embodiment of the present invention is designed to be compatible with smartphones and similar devices. Accordingly, a display screen is provided as one of the plurality of operational components. In order to perform the functional test for the display screen, the display screen is illuminated with a diagnostic lighting pattern. The diagnostic lighting pattern is used to better reveal physical damage to the display screen. The externally-derived hardware status for the display screen is received through the specific electrical appliance and may be used in the hardware status report.

An appliance button may also be provided as one of the plurality of operational components. As a part of the functional test for the appliance button, the system prompts the user to depress the appliance button. The response from the specific electrical appliance is used to determine the externally-derived hardware status of the appliance button. Specifically in this case, if the act of depressing the appliance button generates a response from the specific electrical appliance, it can be determined that the appliance button is functioning properly. The externally-derived hardware status for the appliance button is received through the specific electrical appliance and may be used in the hardware status report.

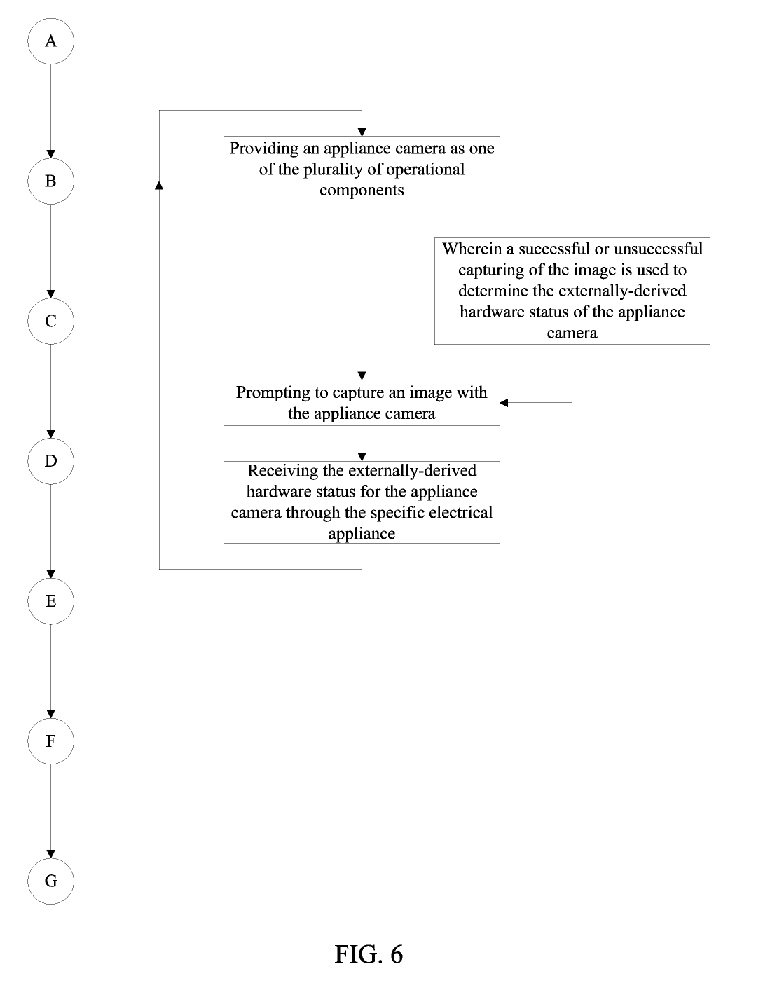

In reference to FIG. 6, an appliance camera may also be provided as one of the plurality of operational components. As a part of the functional test for the appliance camera, the system prompts the user to capture an image with the appliance camera. A successful or unsuccessful capturing of the image is used to determine the externally-derived hardware status of the appliance camera. Specifically in this case, if an image is successfully captured by the appliance camera, it can be determined that the appliance camera is functioning properly. The externally-derived hardware status for the appliance camera is received through the specific electrical appliance and may be used in the hardware status report.

In the first embodiment of the present invention, an appliance monitoring device is provided. The appliance monitoring device is externally attached and communicably coupled to the specific electrical appliance. The appliance monitoring device is designed to work with appliances which are otherwise unable to be programmed to detect malfunctions or establish an online connection with the external server. It is preferred that the appliance monitoring device is communicably coupled to the electrical appliance via a Bluetooth connection; however, other connection methods may alternatively be used. In this embodiment, steps (B) through (G) are executed with the appliance monitoring device.

In the first embodiment of the present invention, wherein the claims filing process is automatic, user identification information and the product type for the specific appliance device are provided to the system. The user identification information and the product type may either be provided to the system by the user or the insurance provider. This may be done as an initial setup for the system or may be provided at the time in which a claim needs to be filed. In reference to FIG. 2, the hardware malfunction is extracted from the hardware status report. The user identification information, the product type, and the hardware malfunction are compiled into the damage claim. At this point, the damage claim may be communicated to the external server.

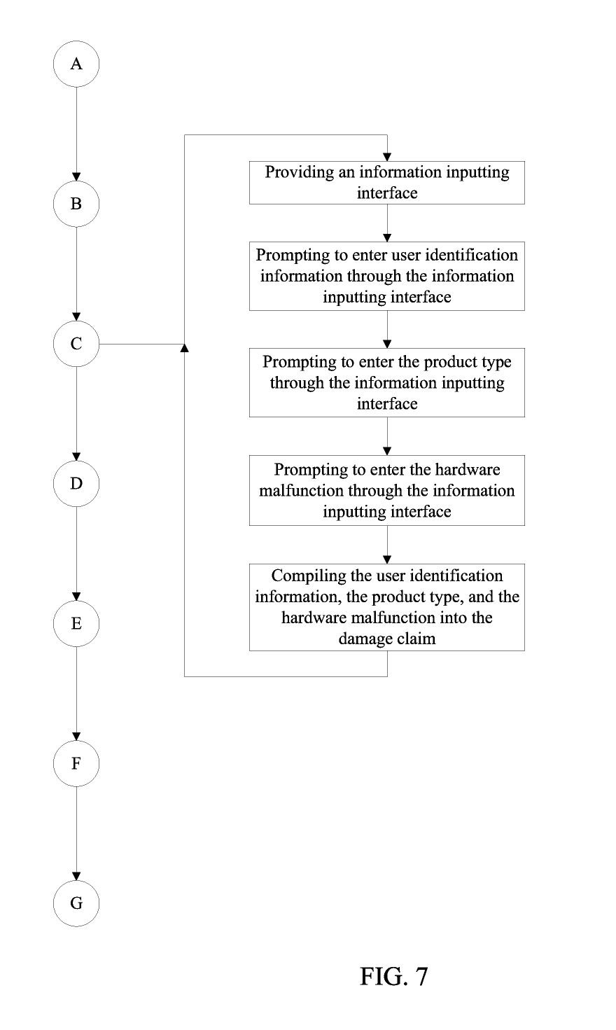

In the second embodiment of the present invention, wherein the claims filing process is user-driven, an information inputting interface is provided. In reference to FIG. 7, the system prompts the user to enter user identification information through the information inputting interfacing. The system then prompts the user to enter the product type and the hardware malfunction through the information inputting interface. The user identification information, the product type, and the hardware malfunction are compiled into the damage claim which may then be communicated to the external server.

After the user receives a reply notification, the user may proceed with either receiving reimbursement for damage to their electrical appliance or abandon the claim. At this point, a client response is forwarded from the user contact information to the external server, wherein the client response is in reference to the reply notification. The damage claim is assigned with an active status on the external server if the client response includes a user confirmation. Alternatively, the damage claim is assigned with an inactive status on the external server if the client response includes a user rejection. If the damage claim is assigned an active status, the insurance provider becomes responsible for repairing or replacing the specific electronic device.

Although the invention has been explained in relation to its preferred embodiment, it is to be understood that many other possible modifications and variations can be made without departing from the spirit and scope of the invention as hereinafter claimed.

What is claimed is:

1. A method of detecting damage and filing an insurance claim for an electrical appliance by executing computer-executable instructions stored on a non-transitory computer-readable medium, the method comprises the steps of:
(A) providing an external server, wherein the external server manages a plurality of electrical appliance profiles, and wherein each of the plurality of electrical appliance profiles includes a product description and damage coverage information;
(B) generating a hardware status report for a specific electrical appliance by executing a hardware diagnostic process;
(C) generating a damage claim by executing a claims filing process, if a hardware malfunction is included in the hardware status report;
(D) communicating the damage claim to the external server, wherein the damage claim includes the hardware malfunction and a product type for the specific electrical appliance;
(E) comparing the product type to the profile description for each of the plurality of electrical appliance profiles in order to identify a matching profile for the specific electrical appliance, wherein the matching profile is from the plurality of electrical appliance profiles;
(F) searching for the hardware malfunction within the damage coverage information of the matching profile in order to determine an eligibility status of the damage claim; and
(G) sending a reply notification to a user contact information associated with the specific electrical appliance, wherein the reply notification includes the eligibility status.

2. The method of detecting damage and filing an insurance claim for an electrical appliance by executing computer-executable instructions stored on a non-transitory computer-readable medium, the method as claimed in claim 1 comprises:
providing a plurality of operational components for the specific electrical appliance;
initiating the hardware diagnostic process by polling the plurality of operational components in order to assess an internally-derived functional status for each of the plurality of operational components; and
compiling the internally-derived functional status for each of the plurality of operational components into the hardware status report.

3. The method of detecting damage and filing an insurance claim for an electrical appliance by executing computer-executable instructions stored on a non-transitory computer-readable medium, the method as claimed in claim 1 comprises:
providing a plurality of operational components for the specific electrical appliance;
triggering the hardware diagnostic process by detecting a traumatic incident to the specific electrical appliance;
prompting to perform a functional test for each of the plurality of operational components;
retrieving an externally-derived functional status for each of the plurality of operational components; and
compiling the externally-derived functional status for each of the plurality of operational components into the hardware status report.

4. The method of detecting damage and filing an insurance claim for an electrical appliance by executing computer-executable instructions stored on a non-transitory computer-readable medium, the method as claimed in claim 1 comprises:
providing an accelerometer for the specific electrical appliance;
receiving a measured acceleration for the specific electrical appliance from the accelerometer;
comparing the measured acceleration to a specified acceleration threshold in order to detect the traumatic incident, wherein the specified acceleration threshold is associated with potential physical damage to the specific electrical appliance; and
initiating the hardware diagnostic process,
if the measured acceleration is greater than the specified acceleration threshold.

5. The method of detecting damage and filing an insurance claim for an electrical appliance by executing computer-executable instructions stored on a non-transitory computer-readable medium, the method as claimed in claim 1 comprises:
providing a display screen as one of the plurality of operational components;
illuminating the display screen with a diagnostic lighting pattern, wherein the diagnostic lighting pattern is used to better reveal physical damage to the display screen; and
receiving the externally-derived hardware status for the display screen through the specific electrical appliance.

6. The method of detecting damage and filing an insurance claim for an electrical appliance by executing computer-executable instructions stored on a non-transitory computer-readable medium, the method as claimed in claim 1 comprises:
providing an appliance button as one of the plurality of operational components;
prompting to depress the appliance button, wherein a response from the specific electrical appliance is used to determine the externally-derived hardware status of the appliance button; and
receiving the externally-derived hardware status for the appliance button through the specific electrical appliance.

7. The method of detecting damage and filing an insurance claim for an electrical appliance by executing computer-executable instructions stored on a non-transitory computer-readable medium, the method as claimed in claim 1 comprises:
providing an appliance camera as one of the plurality of operational components;
prompting to capture an image with the appliance camera, wherein a successful or unsuccessful capturing of the image is used to determine the externally-derived hardware status of the appliance camera; and
receiving the externally-derived hardware status for the appliance camera through the specific electrical appliance.

8. The method of detecting damage and filing an insurance claim for an electrical appliance by executing computer-executable instructions stored on a non-transitory computer-readable medium, the method as claimed in claim 1 comprises:
providing an appliance monitoring device, wherein the appliance monitoring device is externally attached and communicably coupled to the specific electrical appliance; and
executing steps (B) through (G) with the appliance monitoring device.

9. The method of detecting damage and filing an insurance claim for an electrical appliance by executing computer-executable instructions stored on a non-transitory computer-readable medium, the method as claimed in claim 1 comprises:
providing user identification information and the product type for the specific electrical appliance;
extracting the hardware malfunction from the hardware status report; and
compiling the user identification information, the product type, and the hardware malfunction into the damage claim.

10. The method of detecting damage and filing an insurance claim for an electrical appliance by executing computer-executable instructions stored on a non-transitory computer-readable medium, the method as claimed in claim 1 comprises:
providing an information inputting interface;
prompting to enter user identification information through the information inputting interface;
prompting to enter the product type through the information inputting interface;
prompting to enter the hardware malfunction through the information inputting interface; and
compiling the user identification information, the product type, and the hardware malfunction into the damage claim.

11. The method of detecting damage and filing an insurance claim for an electrical appliance by executing computer-executable instructions stored on a non-transitory computer-readable medium, the method as claimed in claim 1 comprises:
forwarding a client response from the user contact information to the external server, wherein the client response is in reference to the reply notification;
assigning the damage claim with an active status on the external server,
if the client response includes a user confirmation; and
assigning the damage claim with an inactive status,
if the client response includes a user rejection.
